(19) United States
(12) Patent Application Publication
(10) Pub. No.: US 2026/0125267 A1
(43) Pub. Date: May 7, 2026

(54) Catalytic Process for Synthesizing Carbon Nanomaterials and Producing Hydrogen from Light Alkanes and Alkenes

(71) Applicant: Chasm Advanced Materials, Inc., Canton, MA (US)

(72) Inventors: Ricardo A. Prada Silvy, Norman, OK (US); David J. Arthur, Braintree, MA (US)

(73) Assignee: Chasm Advanced Materials, Inc., Canton, MA (US)

(21) Appl. No.: 19/397,919

(22) Filed: Nov. 22, 2025

Related U.S. Application Data
(63) Continuation of application No. PCT/US25/24810, filed on Apr. 15, 2025.
(60) Provisional application No. 63/634,706, filed on Apr. 16, 2024.

(51) Int. Cl. C01B 32/162; B01J 21/04; B01J 23/02; B01J 23/75; B01J 23/755; B01J 23/882; B01J 35/30; B01J 35/40; C01B 3/26

(52) U.S. Cl. CPC C01B 32/162; B01J 21/04; B01J 23/02; B01J 23/75; B01J 23/755; B01J 23/882; B01J 35/394; B01J 35/40; C01B 3/26; C01B 2202/06; C01P 2002/88; C01P 2004/03; C01P 2004/133

(57) ABSTRACT

A method of producing one or both of carbon nanotubes (CNT) and hydrogen in the reaction zone of a rotary tube reactor or a fluidized bed reactor that has an outlet. The reaction zone is heated to a reaction temperature between 60° and 900° C. A CNT catalyst is provided into the reaction zone at the reaction temperature. The CNT catalyst includes a transition-metal active catalyst supported on metal oxide particles having a high specific surface area. A process gas is flowed through the reaction zone. The process gas is a gaseous mixture of a hydrocarbon and hydrogen. The hydrocarbon includes at least one of methane, ethane, propane, butane, iso-butane, propene, 1-butene, 2-butene, and iso-butene. The hydrocarbon decomposes at the catalyst sites into CNT and hydrogen. Hydrogen is separated from the gases that exit the reactor through the reactor outlet.

### CROSS-REFERENCE TO RELATED APPLICATION

This application claims priority of International Patent Application PCT/US25/24810, filed on Apr. 15, 2025, which itself claimed priority of Provisional Patent Application 63/634,706, filed on Apr. 16, 2024. The disclosure of these priority applications are incorporated by reference herein, for all purposes.

### BACKGROUND OF THE INVENTION

Since the invention of carbon nanotubes (CNTs) in the early 1990s, there has been a steady increase in the number of their industrial applications. However, their current costs and production capacity are limitations for their use in certain commercial applications. That is why significant efforts have been made in research and development of new highly active and selective catalysts for the production of carbon nanomaterials using low-cost raw materials. Catalytic reactors with higher production capacity operated in continuous mode have also been designed, along with clean processes where the utilization of carbon sources is maximized through recycling. Hydrogen, considered a by-product of the reaction, is harnessed to generate energy or heat or in other industrial uses. These new processes are designed to avoid the generation of CO₂, one of the greenhouse gases, that is created by burning the carbon source that has not been converted during the production process of carbon nanomaterials.

Carbon nanotubes are commercially produced using the catalytic chemical vapor deposition method (CCVD). There are two main production processes that utilize catalysts based on transition metals from the periodic table of elements, typically Fe, Mo, Ni, Co, and combinations of these metals, either supported on a substrate such as SiO₂, Al₂O₃, MgO, etc., or unsupported. The synthesis of CNTs using supported catalysts is generally carried out in fluidized bed reactors in batch or semi-continuous operation mode, or in rotary tube reactors in continuous operation mode. Rotary tube reactors have demonstrated significant advantages over fluidized bed reactors for large-scale production of CNTs due to their equipment simplicity, operational flexibility, reduced maintenance requirements, and lower production costs.

Ethylene has been widely used as a carbon source in the industrial production of carbon nanotubes due to several advantages. Ethylene is widely available in the petrochemical industry and is produced on a large scale. Ethylene is a relatively pure and homogeneous chemical compound, facilitating its handling and processing in the synthesis of carbon nanotubes. The purity of the precursor is crucial for obtaining high-quality nanotubes. The use of ethylene as a precursor allows greater control over synthesis conditions, such as temperature, pressure, and gas composition, which can influence the structural and morphological properties of the produced carbon nanotubes. Ethylene can promote rapid and efficient growth of carbon nanotubes, resulting in higher production yields compared to other carbon sources.

The high consumption of ethylene in polymer and plastic production processes, as well as other petrochemical intermediate products, may pose a limitation to its supply for producing carbon nanotubes on the scale of thousands of metric tons per year. This scale of production is required for certain applications. For example, in the production of advanced construction materials, where 1 metric ton of cement requires a consumption of between 1 to 2 kg of CNTs. Consequently, additional research and development efforts are focusing on utilizing alternative carbon sources, such as natural gas (mainly methane and ethane), light alkanes (propane, butane, iso-butane), and other olefins (propylene, butene), due to their widespread availability, aiming to lower the production costs of carbon nanotubes. While these carbon sources can serve as precursors in CNT synthesis, they may require varying synthesis conditions and different types of active and selective catalysts. The selection of alternative carbon sources will be based on factors such as availability, cost, required purity, synthesis control, and specific production process objectives.

The catalyst and reaction conditions play a crucial role in the synthesis of CNTs, as they can significantly influence the quality, morphology, and yield of the produced nanotubes. Some ways in which the catalyst and reaction conditions impact the synthesis of CNTs include the following.

The most used catalysts for CNT synthesis are iron (Fe), cobalt (Co), and nickel (Ni), although other metals have also been used as catalysts.

The type of catalyst can affect the structural properties of the produced nanotubes, as well as their performance and selectivity.

The size and distribution of catalyst particles can influence the nucleation and growth of carbon nanotubes. Catalysts with uniform particle sizes and well-controlled distributions typically produce carbon nanotubes with more homogeneous properties.

Reaction temperature is a critical parameter that affects the reaction kinetics and morphology of carbon nanotubes. Higher temperatures often favor a faster growth rate of nanotubes. However, they may also increase the likelihood of forming other undesired products or degrading the nanotubes. Sintering of the active phase can occur at high temperatures, leading to a decrease in catalyst activity and an increase in CNT diameter.

Reaction pressure and gas composition can also influence CNT synthesis. For example, introducing carbon gases such as hydrocarbons (e.g., ethylene, natural gas) or carbon monoxide (CO) along with a carrier gas (such as hydrogen) can affect reaction kinetics and the quality of the produced nanotubes.

Reaction time is also an important factor. Longer reaction times may allow for more extensive nanotube growth, but they may also increase the likelihood of structural defects.

The reaction atmosphere can influence the purity and structure of carbon nanotubes. For example, removing oxygen and other reactive gases can help prevent the formation of impurities and defects in the nanotubes.

A careful control of these parameters can be important to obtain carbon nanotubes with the desired properties for various industrial applications.

Burning excess process gases in refineries and petrochemical plants is a common practice known as “flaring.” This occurs when more gases are generated than can be safely used or stored. While desirable in some circumstances, it has environmental and economic consequences. Hydrocarbons and olefins, valuable resources, could be used more productively instead of being simply burned, wasting energy and reducing plant efficiency. Strict regulations on flaring emissions exist in many regions, with significant fines for non-compliance, leading to additional costs. Many companies are adopting strategies to reduce flaring, including investing in gas capture and recycling technologies, such as re-injection into production processes or conversion into useful products. Cleaner and more efficient technologies for processing hydrocarbons and olefins are also being developed, reducing the amount of residual gases generated.

Hydrogen as a byproduct during carbon nanotube synthesis can offer a viable alternative for commercial production in an environmentally friendly manner without generating greenhouse emissions. This route is beneficial from an environmental perspective, as it utilizes the chemical energy contained in hydrocarbons as a source of hydrogen, thus avoiding CO₂ generation associated with the complete combustion of these compounds. Furthermore, separating the gas output from the reactor and utilizing the hydrogen produced during carbon nanotube synthesis can improve the overall efficiency of the process and reduce the carbon footprint. The feasibility and effectiveness of this approach may depend on various factors, including the specific synthesis technology used, the availability and cost of the carbon source, as well as the ability to capture and efficiently utilize the generated hydrogen.

The combustion of flaring gas constitutes a major contributor to global greenhouse gas emissions, primarily through the release of carbon dioxide, methane in cases of incomplete combustion and black carbon (particulate matter), all of which exhibit significant radiative forcing potential. In 2022, it is estimated that approximately 139 billion cubic meters of gas were flared worldwide, representing an annual emission of nearly 500 million metric tons of CO₂-equivalent (MtCO₂e). Emissions associated with flaring typically include CO₂, as the predominant product of hydrocarbon oxidation, CH₄, when combustion is incomplete, carbon black, composed of fine carbonaceous particles with high global warming potential, nitrogen oxides (NOₓ) and other atmospheric pollutants. Methane poses a significant environmental concern due to its global warming potential, which is 84-86 times greater than that of CO₂ over a 20-year timeframe.

The composition of flare gas in oil refineries and petrochemical complexes is highly variable and is influenced by the nature of the feedstock, the specific process units in operation, and prevailing process conditions. Typically, flare gas is a complex mixture of hydrocarbons and inorganic gases, vented for safety, overpressure control, or system purging. In petroleum refining operations, the flare gas stream commonly consists of: methane (CH₄): 30-60%, ethane (C₂H₆): 5-20%, propane and butanes (C₃-C₄): 5-15%, hydrogen (H₂): 0-20%, hydrogen sulfide (H₂S): 0.01-5%, carbon oxides (CO₂, CO): 1-5% and water vapor in variable concentration.

In petrochemical plants, flare gas compositions are typically enriched with light alkanes and alkenes, and may include methane, ethane, ethylene, propane, propylene, butenes, butadiene, hydrogen, CO, CO₂, light aromatics (benzene, toluene, xylene), sulfur species (H₂S, mercaptans, organic sulfides) these components originate primarily from feedstock processing of natural gas or naphtha.

Routine flaring not only results in substantial environmental degradation but also represents a significant loss of recoverable energy resources. With appropriate processing, flare gas can be repurposed as a feedstock for the synthesis of high-value materials, such as carbon nanomaterials and hydrogen gas, offering a dual benefit of emissions mitigation and resource valorization.

### SUMMARY OF THE INVENTION

The present invention relates to a green and environmentally friendly process for synthesizing multi-walled carbon nanotubes and CNT hybrid materials. This disclosure also relates to producing hydrogen using different carbon sources and catalyst formulations in both rotary tube and fluidized bed reactors. The carbon sources involved in this invention include at least light alkanes (methane, ethane, propane, and butane) and alkenes (ethylene, propylene, and butene). The supported metal catalysts used are based on Co, Co—Fe, and Co—Mo—Fe active phases, supported on alumina and MgO—Al₂O₃ substrates. Reaction temperatures range between 675 and 750° C., and up to 900° C., and reaction times range between 10 and 20 minutes, respectively.

This invention discloses a catalytic process for producing low-cost carbon nanomaterials and hydrogen by using light alkanes and alkenes as carbon sources in rotary tube and fluidized bed reactors. The process is environmentally friendly. The unreacted carbon source can be recycled, avoiding the emission of CO₂ by flaring. Or, the unreacted carbon source gas can be flared, thus reducing CO₂ emissions. The hydrogen produced can be separated from the effluent gas stream, for example by a membrane system. The hydrogen can be stored and can be used for multiple chemical processes or for generating power and heat.

Catalysts employed for the synthesis of carbon nanotubes with optimized formulations of active phase are used, and process parameters are optimized to obtain carbon nanotubes and hydrogen with high selectivity and productivity through the catalytic decomposition of light alkanes and alkenes as economically feasible raw materials. Catalysts are based on Co or a combination of other transition metal oxides (Co, Fe, Mo) supported on high specific surface area Al₂O₃ and MgO—Al₂O₃ (200-400 m²/g) substrates. Details of the catalyst preparation procedure are described in U.S. Pat. No. 9,855,551, and PCT/US2024/016439, the disclosures of which are incorporated herein by reference and for all purposes.

CNTs and hybrid nanomaterials are synthesized in a rotary tube reactor or fluidized bed reactor using different carbon sources (methane, ethane, propane, butane, iso-butane, ethylene, propene, 1-butene, 2-butene, and iso-butene, and potentially other hydrocarbons) at a temperature ranging between 60° and 900° C., atmospheric pressure, and a residence time of the material in the reaction zone that varies between 5 and 20 minutes, depending on the desired carbon yield for the specific application. The process gas consists of a gaseous mixture composed primarily of one or more hydrocarbons, with a lesser amount of hydrogen. In some examples the hydrogen is present in proportions ranging from 40% V to 95% V of the hydrocarbon. In an example the hydrocarbon source in the process gas can comprise or consist of natural gas. The natural gas will typically first be processed to reduce impurities such as sulphur compounds and carbon dioxide. The catalyst is introduced in a flow of inert gas (N₂, He or Ar) at the reaction temperature before it comes into contact with the process gas.

When the system operates with recycled gas, the unconverted carbon source content varies between 15 and 40% V, preferably between 20 and 30% V. The process design incorporates a series of selective membranes to separate H₂, the inert gas, and unconverted hydrocarbon from the reactor effluent gas stream at the reactor outlet. Consequently, the process is environmentally friendly due to no or very low CO₂ emissions.

The carbon nanotube content in the product ranges from 30 to 95 wt %, depending on the specific commercial application. The content of Al₂O₃ and MgO—Al₂O₃ supports in the catalyst varies between 90-99.5 wt %, and the supported active metals (Co, Fe, Mo) content ranges from 0.5 to 10 wt %. The catalyst grains have a particle size of less than 500 μm when a rotary tube reactor is used and between 150-500 μm when a fluidized bed reactor is used. The Al₂O₃ and MgO—Al₂O₃ supports are composed of elementary particles with sizes ranging from 600 to 1500 nm. During the initial stage of the catalytic reaction, the growth of CNTs causes disaggregation of the elementary particles that form the catalyst grains. As the reaction progresses, these elementary particles are dispersed in a three-dimensional open mesh of carbon nanotubes. The morphological properties of the support (shape and size of the particles) as well as the composition of the active phase in the catalyst determine the structure and morphology of the three-dimensional mesh of carbon nanotubes. The more open and less tangled the carbon nanotube mesh is, the easier it is to disperse with less energy usage in mixing equipment for specific applications.

The CNT and hybrid materials can be used in applications related to energy storage, reinforcement of electro-mechanical properties of polymers and plastics, or in advanced construction materials. Hydrogen, produced by catalytic decomposition reactions of the different hydrocarbon sources, can be used for power and heat generation as fuel or in other catalytic industrial processes.

The hydrogen production depends on its relative composition in the carbon source and its reactivity. Table 1 shows the H/C atomic ratio for different hydrocarbon compounds. Light paraffins have a higher H/C ratio value than olefins. However, the reactivity of olefins is much higher than that of paraffins at lower reaction temperatures. Because of this, the synthesis of CNTs in the presence of olefins as carbon sources requires catalysts with lower active metal content than paraffins, offering a competitive advantage in terms of reaction efficiency and the structural and morphological properties of CNTs. As the number of carbon atoms in the hydrocarbon increases, its reactivity also increases. Methane has the highest H/C ratio among hydrocarbons. However, due to its high molecular stability, it requires highly active catalysts and elevated temperatures for carbon nanotube synthesis to occur. Larger and more complex hydrocarbons tend to be more reactive and therefore more useful as precursors in these synthesis processes.

TABLE 1
H/C atomic ratio for different hydrocarbon compounds.

| | Chemical | H/C | grams H₂/grams |
|---|---|---|---|
| Hydrocarbon | Formulation | ratio | carbon |
| Methane | CH₄ | 4.00 | 0.333 |
| Ethane | C₂H₆ | 3.00 | 0.250 |
| Propane | C₃H₈ | 2.67 | 0.222 |
| Iso-Butane | C₄H₁₀ | 2.50 | 0.208 |
| Ethylene | C₂H₄ | 2.00 | 0.167 |
| Propene | C₃H₆ | 2.00 | 0.167 |
| 1,2 and Iso-Butene | C₄H₈ | 2.00 | 0.167 |

In one aspect a method of producing at least carbon nanotubes (CNT) in the reaction zone of a rotary tube reactor or a fluidized bed reactor that has an outlet, wherein the reaction zone is heated to a reaction temperature between 60° and 900° C., includes providing into the reaction zone at the reaction temperature a CNT catalyst comprising a transition-metal active catalyst supported on metal oxide particles having a high specific surface area, flowing through the reaction zone a process gas comprising a gaseous mixture of a hydrocarbon and hydrogen, wherein the hydrocarbon comprises at least one of methane, ethane, propane, butane, iso-butane, propene, 1-butene, 2-butene, and iso-butene, wherein the hydrocarbon decomposes at the catalyst sites into CNT and hydrogen and separating hydrogen from the gases that exit the reactor through the reactor outlet.

In some examples the hydrogen volume in the process gas is from 40% to 95% of the hydrocarbon volume. In some examples the method further comprises recycling back into the process gas at least one of separated hydrogen and hydrocarbon gasses. In some examples the CNT comprises from 30 to 95% by weight of the product produced using the reactor. In some examples the metal oxide particles make up from 90 to 99.5% by weight of the CNT catalyst. In some examples the active catalyst makes up from 0.5 to 10% by weight of the CNT catalyst. In some examples the active catalyst of the CNT catalyst is present in the form of catalyst grains that have a particle size of less than 500 microns for the rotary tube reactor and from 150-500 microns for the fluidized bed reactor. In some examples the CNT catalyst metal oxide particles comprise alumina support particles that are composed of elementary particles with sizes ranging from 600 to 1,500 nanometers.

In some examples the hydrocarbon in the process gas comprises methane. In some examples the hydrocarbon in the process gas comprises methane and ethane. In some examples the hydrocarbon in the process gas comprises propane. In some examples the hydrocarbon in the process gas comprises propane and at least one of ethane and butane. In some examples the process gas comprises flare gas. In some examples the process gas comprises natural gas. In some examples the process gas comprises liquified petroleum gas. In some examples the process further comprises removing at least one of sulfur and sulfur compounds from the flare gas before it is flowed through the reaction zone.

In another aspect a process for the production of hydrogen includes providing a rotary tube reactor with a reaction zone, wherein the reaction zone is heated to a reaction temperature between 60° and 900° C., providing into the reaction zone a catalyst comprising a transition-metal active catalyst supported on metal oxide particles having a high specific surface area, flowing through the reaction zone a process gas comprising a gaseous mixture of at least one hydrocarbon and hydrogen, wherein the hydrocarbon comprises at least one of methane, ethane, propane, butane, iso-butane, propene, 1-butene, 2-butene, and iso-butene, wherein the hydrocarbon decomposes at the catalyst sites into carbon and hydrogen and separating hydrogen from the gases that exit the reactor.

In some examples the hydrocarbon further comprises at least one of a C5 compound and a C6 compound. In some examples the C5 compound comprises at least one of pentane, iso-paraffins and olefins. In some examples the C6 compound comprises at least one of benzene, toluene, xylene, paraffins and aromatics.

### BRIEF DESCRIPTION OF DRAWINGS

FIG. 1 is an SEM analysis taken at 10 KX (top row) and 50 KX (bottom row) magnification for MWCNT synthesized using catalyst A (left column) and catalyst B (right column) and ethane as carbon source at 750° C. and 20 minutes reaction time.

FIG. 2 includes TGA analyses corresponding to MWCNT synthesized using Catalysts A and B (left and right respectively), ethane as carbon source, at 750° C., 20 minutes reaction time and 80% ethane.

FIG. 3 includes SEM analyses taken at 10 KX (top row) and 50 KX (bottom row) magnification for the MWCNT synthesized using ethane as carbon source using Catalyst A at different reaction temperatures (675, 700, 730 and 750° C., left to right columns) and 10 minutes reaction time.

FIG. 4 includes SEM images taken at 10KX (top row) and 50 KX (bottom row) magnification of MWCNT synthesized using Catalyst B and propane as carbon source at different temperatures (675, 700, 730 and 750° C., left to right columns) and 15 minutes reaction time.

FIG. 5 includes SEM images taken at 10 KX (top row) and 50 KX (bottom row) magnifications corresponding to the carbon nanotubes synthesized using catalyst A, iso-butane as the carbon source at 675° C., 700° C., 730° C., and 750° C. (columns from left to right, respectively), with a reaction time of 15 minutes.

FIG. 6 includes SEM images taken at 1KX, 5KX, 10KX, and 50KX magnifications (columns left to right, respectively) of the carbon nanotubes synthesized from both Catalyst A (top row) and Catalyst B (bottom row) using 2-butene as the carbon source at a temperature of 675° C. and a reaction time of 15 minutes.

FIG. 7 includes TGA analyses corresponding to MWCNTs synthesized with Catalyst A in the presence of ethylene (left) and 2-butene (center), and Catalyst B in the presence of 2-butene as the carbon source (right), at 675° C.

FIG. 8 illustrates mechanical strength properties of MWCNT-Al₂O₃ and cement specimens: A comparison between CNTs produced from ethane and ethylene using Catalyst B, as compared to mortar.

FIG. 9 includes SEM images taken at 10 KX and 50 KX magnifications (left to right respectively), where MWCNTs with diameters ranging from 20 to 50 nm are observed.

FIG. 10 presents data from Example 10, showing the variation in MWCNT content as a function of the propane percentage in the gas mixture, as well as the amount of CNT and H₂ produced per gram of catalyst.

FIG. 11 includes SEM images at 5KX magnification of MWCNTs synthesized using different ethane-propane gas mixture compositions (100% propane, 67% propane and 33% ethane, 50% propane and ethane, 33% propane and 67% ethane, and 100% ethane from left to right, respectively).

FIG. 12 is a schematic representation of an exemplary rotary tube reactor design and CNT production process for use in the present invention.

### DETAILED DESCRIPTION OF THE INVENTION

Examples are provided as follow:

Example 1: Synthesis of MWCNTs using ethylene as a carbon source in a rotary tube reactor.

In this example, two catalysts based on Co/Al₂O₃ and CoMoFe/MgO—Al₂O₃, prepared according to prior art (e.g., U.S. Pat. No. 9,855,551, Publications US20230116160A1, and PCT/US2024/016439, the disclosures of which are incorporated by reference herein), were employed (Table 2). The catalyst preparation for the synthesis of CNTs includes the following consecutive steps: a) contacting an aqueous solution containing metallic salts of the active components (a Co salt or combination of Co, Mo, Fe, and Mg salts) with aluminum hydroxides (e.g., boehmite, gibbsite, bayerite, aluminum alkoxides), using conventional impregnation techniques; b) forming a paste or granules of the impregnated material and subjecting it to aging under controlled humidity and temperature for about 2 hours; c) drying the impregnated material in the presence of airflow at temperatures between 25° C., 60° C., and 120° C.; d) sieving the material to a particle size between 30 to 500 microns, according to the type of reactor to be used; and e) calcining the catalyst powder in an oven in the presence of nitrogen or air and nitrogen flow at a temperature between 350° C. and 550° C. The active metal composition is tuned to control the CNT morphology and yield.

The catalysts Co/Al₂O₃ and CoMoFe/MgO—Al₂O₃ are denoted as Catalyst A and Catalyst B, respectively.

TABLE 2
Type of catalyst and metal compositions

| | | Co/Mo/Fe/Mg | |
|---|---|---|---|
| | | composition | |
| Catalyst | Denoted as | (wt %) | Source |
| Co/Al₂O₃ | A | 10.0 | PCT/US2024/016439 |
| CoMoFe/ | B | 1.0/0.5/ | U.S. Pat. No. |
| MgO—Al₂O₃ | | 1.85/0.3 | 9,855,551 B2 |

The synthesis of carbon nanotubes is conducted either in a rotating tube reactor or a fluidized bed reactor, operating at temperatures ranging from 600 to 750° C., while being exposed to a gaseous mixture comprising various carbon sources (such as ethylene, ethane, propane, iso-butane, and 2-butene) along with hydrogen. The catalyst resides in the reaction zone of the reactor for a duration spanning from 5 to 20 minutes, and the composition of carbon source gases in the process gas can vary from 20% to 80% by volume. The ratio of H₂ to carbon source in the process gas ranges between 0.1 and 0.2. Additionally, the catalyst is introduced into the reactor by means of an inert gas flow, typically nitrogen (N₂).

Example 2: Synthesis of MWCNTs using Ethylene as a carbon source in a rotary tube catalytic reactor.

In this example, we compare the behavior of Catalysts A and B in the synthesis of carbon nanotubes using ethylene as the carbon source at temperatures of 675° C., with a residence time of 20 minutes in a rotating tube reactor. The results of these tests are reported in Table 3. The ethylene composition in the process gas is 80% in hydrogen. Catalyst A proved to be more productive in carbon nanotube yield and consequently in hydrogen production per quantity of catalyst used than Catalyst B. These results are attributed to its higher active metal composition.

TABLE 3
Synthesis of MWCNTs in a rotary tube reactor using different catalyst compositions
and ethylene as carbon source at 675° C. and 20 minutes reaction times.

| | | Ethylene | | | MWCNT | | |
|---|---|---|---|---|---|---|---|
| | | composition | | | content in | CNT | |
| | | in the gas | Reaction | Reaction | the | production | H₂ |
| | Carbon | feed | Temperature | time | product | (g · CNT/ | produced |
| Catalyst | source | (V %) | (° C.) | (min) | (wt %) | g · cat) | (L/g · cat) |
| A | Ethylene | 80% | 675 | 20 | 92 | 11.50 | 21.47 |
| B | Ethylene | 80% | 675 | 20 | 89 | 8.09 | 15.10 |

Example 3: Synthesis of MWCNT using different ethane composition, catalysts and reaction times in a rotary tube reactor.

In this example, ethane was used as the carbon source. The synthesis of CNTs was carried out using both catalysts A and B, with an ethane composition in the process gas of 80% v/v, at a reaction temperature and time of 750° C. and 20 minutes, respectively. The results of these catalytic activity tests are shown in Table 4. As can be observed, Catalyst A proved to be more active than Catalyst B to produce MWCNTs and H₂, and it was moderately less active when comparing its activity using ethylene as the carbon source under the same conditions of process gas composition and reaction time (Table 3).

TABLE 4
Synthesis of MWCNTs using ethane as carbon source and different catalysts

| | | | | | MWCNT | | |
|---|---|---|---|---|---|---|---|
| | | Ethane | | | content in | CNT | |
| | | composition | Reaction | Reaction | the | production | H₂ |
| | Carbon | in the feed | Temperature | time | product | (g | produced |
| Catalyst | source | gas (V %) | (° C.) | (min) | (wt %) | CNT/g · cat) | (L/g · cat |
| A | Ethane | 80% | 750 | 20 | 88 | 7.33 | 20.53 |
| B | Ethane | 80% | 750 | 20 | 80 | 4.00 | 11.20 |

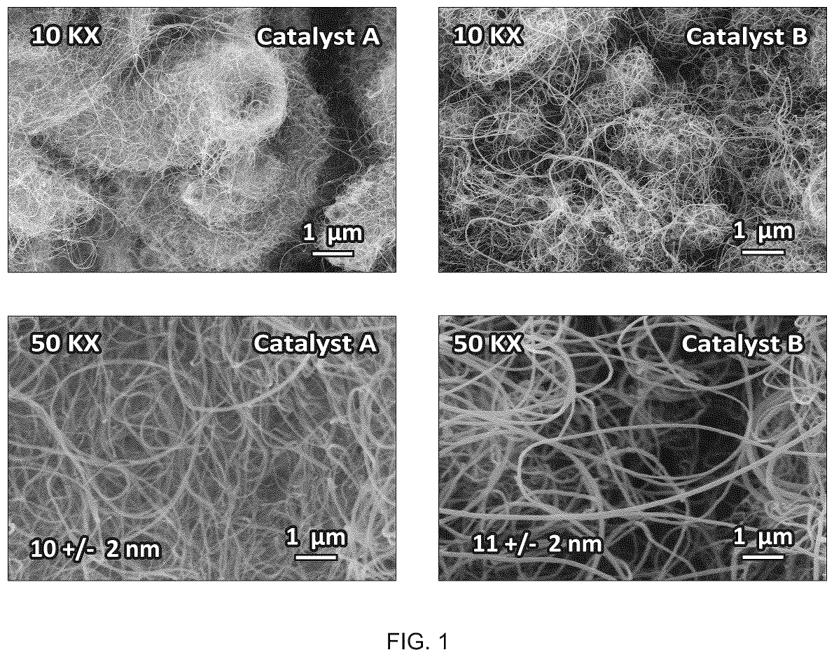

FIG. 1 shows the results of scanning electron microscopy (SEM) analysis conducted on the CNTs samples synthesized using catalysts A and B, and ethane as carbon source, at 750° C. and 20 minutes reaction. The images were taken at magnifications of 10 KX and 50 KX. The nanotubes synthesized with both catalysts A and B exhibit cotton-balls-like morphological properties, with diameters varying in the range of 8 to 13 nm.

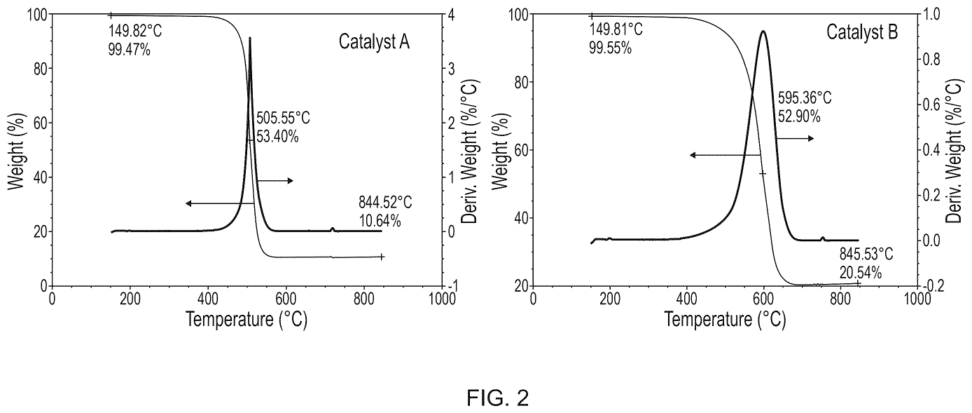

FIG. 2 depicts the thermogravimetric analyses of the carbon nanotubes obtained using catalysts A and B. Both analyses exhibit a single signal, narrower signal located at a lower combustion temperature for catalyst A. These results may be attributed to differences in the morphology of the CNTs observed through SEM analysis and to the combustion capacity of the metallic Co species supported on catalyst A compared to the active Co—Fe—Mo species supported on catalyst B during TGA analysis.

Table 5 presents the results of CNT synthesis using catalyst A and ethane as the carbon source at different compositions in the process gas, temperatures, and reaction times. Decreasing the temperature, ethane composition in the reaction gas, and reaction time below 750° C., 80%, and 20 minutes (Table 4 and 5), respectively, result in a progressive decrease in the production of carbon nanotubes and hydrogen. The high stability of ethane at temperatures below 750° C. means it doesn't decompose enough to supply active carbon (radicals) C*, CH₂*, CH₃*)) to the catalyst and precipitate as graphitic source structures, which limits CNT production. This is why higher temperatures results in a higher MWCNT content in the product.

TABLE 5
Synthesis of MWCNT using Catalyst A and ethane as carbon source at different
reaction temperatures and at 10 and 15 minutes reaction time.

| Ethane | | | MWCNT | | |
|---|---|---|---|---|---|
| composition | Reaction | Reaction | content in | CNT | |
| in the feed | Temperature | time | the product | production | H₂ produced |
| gas (V %) | (° C.) | (min) | (wt %) | (g CNT/g · cat) | (L/g · cat |
| 50 | 675 | 10 | 53 | 1.13 | 3.16 |
| 50 | 700 | 10 | 61 | 1.56 | 4.38 |
| 50 | 730 | 10 | 65 | 1.86 | 5.20 |
| 50 | 750 | 10 | 71 | 2.45 | 6.86 |
| 50 | 700 | 15 | 69 | 2.23 | 6.23 |
| 50 | 750 | 15 | 76 | 3.17 | 8.87 |
| 80 | 700 | 10 | 62 | 1.63 | 4.57 |
| 80 | 700 | 15 | 67 | 2.03 | 5.68 |

Table 6 displays the results of carbon nanotube synthesis using catalyst B, ethane as the carbon source at different compositions in the process gas, and reaction time at 750° C. The production of carbon nanotubes and hydrogen decreases progressively when the ethane composition in the process gas is reduced from 80% v/v to 20 v/v and the reaction time is decreased from 20 to 10 minutes. This is because there is a correlation between the amount of carbon deposited on the catalyst and the gas/solid contact time, which is determined by the ratio of ethylene volume to the amount of catalyst fed into the reactor over a given period of time.

TABLE 6
Synthesis of MWCNT using catalyst B and different ethane composition
in the gas feed and reaction times in a rotary tube reactor.

| Ethane | | | MWCNT | CNT | |
|---|---|---|---|---|---|
| composition in | Reaction | Reaction | content in | production | |
| the gas feed | Temperature | time | the product | (g | H₂ produced |
| (V %) | (° C.) | (min) | (wt %) | CNT/g · cat) | (L/g · cat |
| 80 | 750 | 10 | 78 | 3.55 | 9.93 |
| 60 | 750 | 10 | 76 | 3.17 | 8.87 |
| 40 | 750 | 10 | 74 | 2.85 | 7.97 |
| 20 | 750 | 10 | 67 | 2.03 | 5.68 |
| 80 | 750 | 15 | 79 | 3.76 | 10.53 |
| 80 | 750 | 20 | 80 | 4.00 | 11.20 |

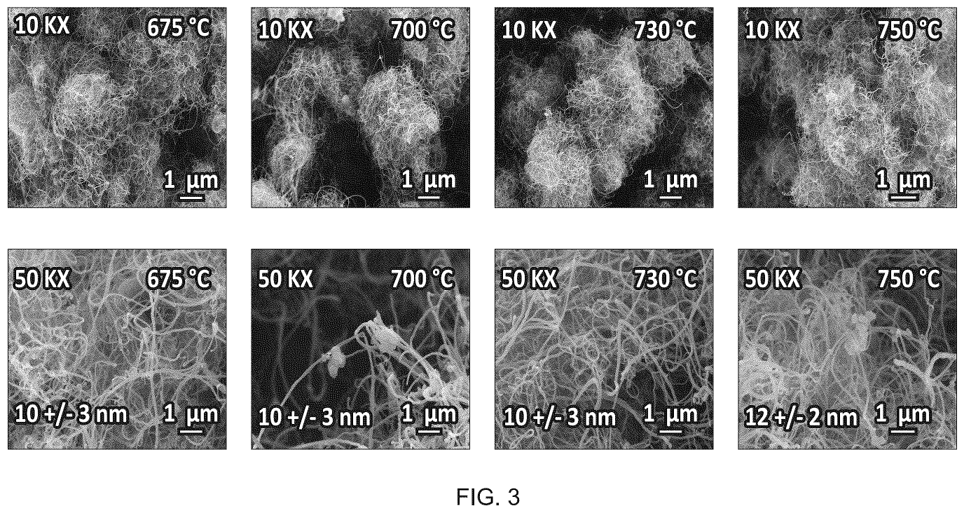

FIG. 3 shows scanning electron microscopy images taken at 10 KX and 50 KX magnifications corresponding to the carbon nanotubes synthesized using catalyst A, ethane as the carbon source at 675° C., 700° C., 730° C., and 750° C., with a reaction time of 10 minutes. In all images, carbon nanotubes forming cotton ball-like structures are observed. The nanotubes are visibly more entangled at 675° C. and 700° C. The sample synthesized at 750° C. shows larger nanotube diameter.

Example 4. Synthesis of Carbon Nanotubes using Catalyst B and propane as carbon source at different reaction temperatures and times in a rotary tube reactor.

In this example, carbon nanotubes were synthesized using the catalyst B and propane as the carbon source at different temperatures and reaction times. In Table 7, the carbon yield increased from 72% to 77% when the reaction temperature was increased from 675° C. to 700° C. and then experienced a slight increase in carbon content in the samples when the reaction temperature was progressively increased between 700° C. and 750° C. The production of MWCNTs and hydrogen per amount of catalyst used increased with the increase in reaction time from 10 minutes to 15 minutes. When comparing the reactivity of propane and ethane under the same reactor operation conditions, the product obtained shows a similar carbon content (79-80 wt %), but the production of hydrogen per gram of catalyst is lower (10.53 vs 9.96). (Tables 6 and 7).

TABLE 7
Synthesis of MWCNT using propane as a carbon source and Catalyst B at
different reaction temperatures and at 10 and15 minutes reaction times.

| Propane | | | MWCNT | CNT | |
|---|---|---|---|---|---|
| composition in | Reaction | Reaction | content in | production | |
| the gas feed | Temperature | time | the product | (g | H₂ produced |
| (V %) | (° C.) | (min) | (wt %) | CNT/g · cat) | (L/g · cat) |
| 80 | 675 | 15 | 72 | 2.57 | 6.40 |
| 80 | 700 | 15 | 77 | 3.35 | 8.33 |
| 80 | 730 | 15 | 79 | 3.76 | 9.36 |
| 80 | 750 | 15 | 80 | 4.00 | 9.96 |
| 80 | 675 | 10 | 64 | 1.78 | 4.42 |
| 80 | 700 | 10 | 67 | 2.03 | 5.05 |

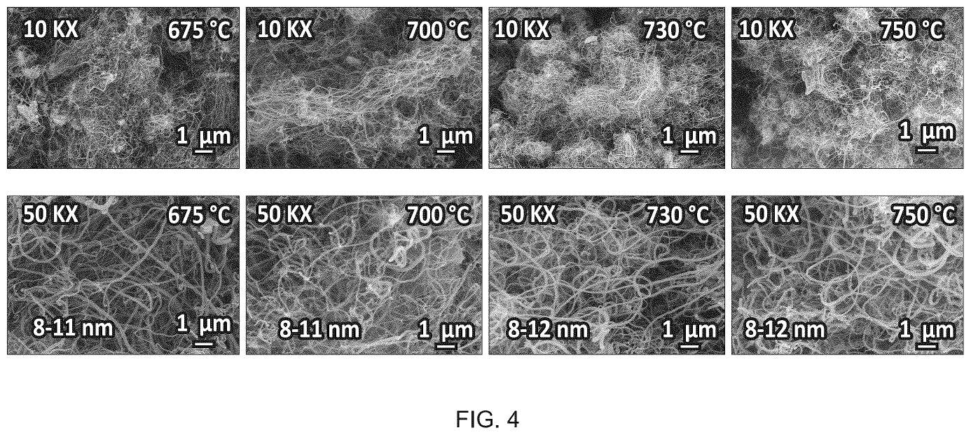

FIG. 4 displays SEM images taken at 10 KX and 50 KX magnifications ofthe samples of MWCNTs synthesized using catalyst B, propane as the carbon source, different temperatures (675, 700, 730 and 750° C., left to right columns), and a reaction time of 15 minutes. The images depict WCNTs with a cotton-ball-like morphology with diameters varying in the range of (8 to2 nm.

Example 5. Synthesis of Carbon Nanotubes using Catalyst A and iso-butane as carbon source at different reaction temperatures in a rotary tube reactor.

In this example, MWCNTs were synthesized using catalyst A, isobutane as the carbon source at different temperatures, and a reaction time of 15 minutes. See results in Table 8. The carbon content in the samples increased from 7400 to 9000 as the reaction temperature progressively increased from 675C to 750° C. Isobutane proved to be more reactive than ethane in the production of CNTs and hydrogen per amount of catalyst used.

TABLE 8
Synthesis of MWCNT using iso-butane as a carbon source and Catalyst
A at different reaction temperatures and 15 minutes reaction time.

| Iso-butane | | | MWCNT | CNT | |
|---|---|---|---|---|---|
| composition in | Reaction | Reaction | content in | production | |
| the gas feed | Temperature | time | the product | (g | H₂ produced |
| (V %) | (° C.) | (min) | (wt %) | CNT/g · cat) | (L/g · cat) |
| 80 | 675 | 15 | 74 | 2.85 | 6.64 |
| 80 | 700 | 15 | 87 | 6.69 | 15.62 |
| 80 | 730 | 15 | 88 | 7.33 | 17.11 |
| 80 | 750 | 15 | 90 | 9.00 | 21.00 |

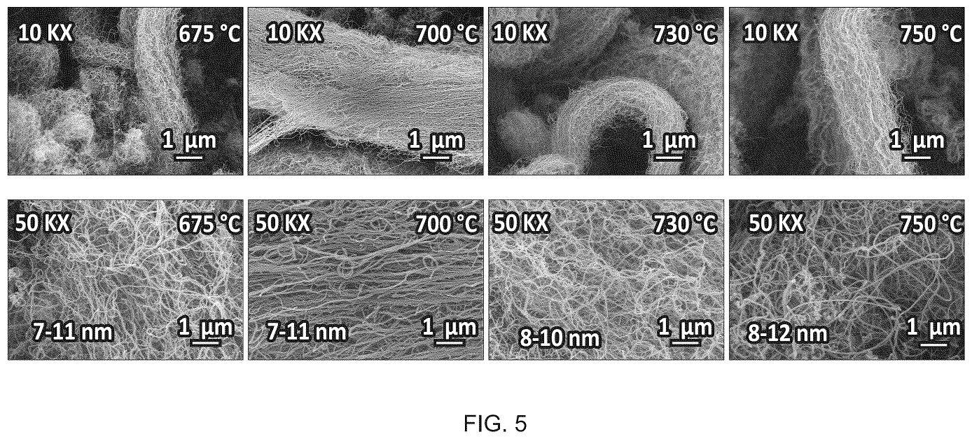

FIG. 5 shows SEM images taken at 10 KX (top row) and 50 KX (bottom row) magnifications corresponding to the carbon nanotubes synthesized using catalyst A, iso-butane as the carbon source at 675° C., 700° C., 730° C., and 750° C. (columns from left to right, respectively), with a reaction time of 15 minutes. In this case, MWCNTs are observed exhibiting bundle-like structures with lengths exceeding 5 microns. The sample obtained at 730° C. showed more uniform bundles and carbon nanotubes with diameters ranging from 8 to 10 nm.

Example 6: Synthesis of carbon nanotubes using Catalysts A and B and 2-butene as carbon source at different temperatures in a rotary tube reactor.

In this example, carbon nanotubes were synthesized using catalysts A and B, with 2-butene as the carbon source at a temperature of 675° C. and a reaction time of 15 minutes. Table 9 shows the results obtained in the synthesis of MWCNTs using both catalysts. Catalyst A proved to be more active in producing carbon nanotubes and hydrogen, achieving conversion levels of 89% and a hydrogen production per catalyst amount of 15.1 L/g.cat. 2-Butene was more reactive than iso-butane when the reactor was operated under the same operating conditions (Table 8).

TABLE 9
Synthesis of MWCNT using 2-butene as a carbon source and Catalyst
A at different reaction temperatures and 15 minutes reaction time.

| | | | | MWCNT | | |
|---|---|---|---|---|---|---|
| 2-butene | | | | content in | CNT | |
| composition | | Reaction | Reaction | the | production | H₂ |
| in the gas | | Temperature | time | product | (g | produced |
| feed (V %) | Catalyst | (° C.) | (min) | (wt %) | CNT/g · cat) | (L/g · cat) |
| 80 | A | 675 | 15 | 89 | 8.09 | 15.10 |
| 80 | B | 675 | 15 | 78 | 3.55 | 6.62 |

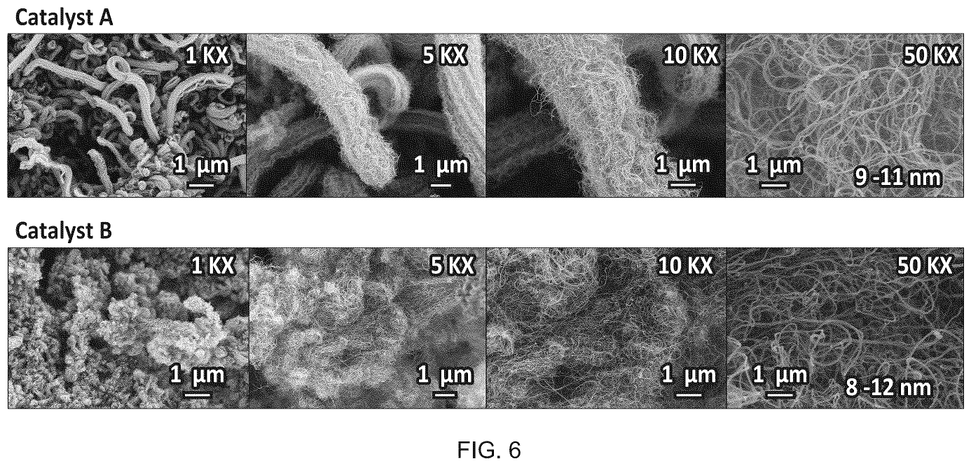

FIG. 6 shows SEM images taken at 1KX, 5KX, 10KX, and 50KX magnifications (columns left to right, respectively) of the carbon nanotubes synthesized from both Catalyst A (top row) and Catalyst B (bottom row) using 2-butene as the carbon source at a temperature of 675° C. and a reaction time of 15 minutes. It can be clearly seen that Catalyst A produces CNT bundles with a length of 5 microns, while Catalyst B produces CNTs with a morphology resembling cotton balls. In both samples, the diameter of the CNTs varies between 8 and 12 nm.

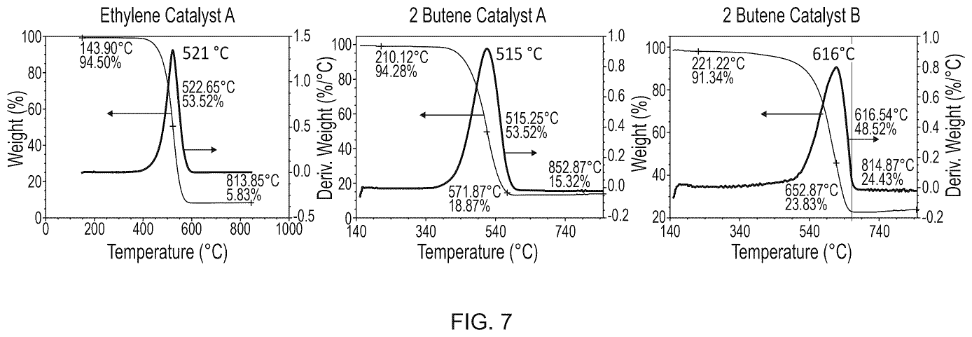

FIG. 7 includes TGA analyses corresponding to MWCNTs synthesized with Catalyst A in the presence of ethylene (left) and 2-butene (center), and Catalyst B in the presence of 2-butene as the carbon source (right), at 675° C. The MWCNTs obtained with the catalyst A using ethylene and 2-butene show a similar maximum combustion temperature (521° C. and 525° C.), while the carbon nanotubes obtained with catalyst B exhibit a higher maximum combustion temperature (616° C.). The morphology of the carbon nanotubes, the degree of entanglement, the diameter of the CNTs, the presence of structural defects, the type of active metal and composition, and the content of residual catalyst influence their combustion properties during TGA analysis. Given the similarities observed in the morphological properties of carbon nanotubes synthesized using ethylene and 2-butene, it could be expected that both exhibit similar behavior in commercial applications where these products are employed.

Example 7. Synthesis of MWCNTs using Catalyst B and ethane as a carbon source in a fluidized bed reactor.

In this example, the synthesis of MWCNTs was carried out in a fluidized bed reactor using 5 grams of catalyst B, a flow of a gas mixture of ethane/H₂ (75% V ethane) of 15 L/min, temperatures of 675° C., 700° C., 730° C., and 750° C., and a reaction time of 10 minutes. The results of these reactor runs are shown in Table 10. The same behavior observed in example 4 (Table 5) can be observed in the tests carried out with catalyst A as the reaction temperature increases. However, the carbon content in the products obtained with catalyst B, the amount of MWCNTs, and H₂ produced per amount of catalyst used, are much lower compared to catalyst A.

Table 10 also shows the results of surface conductivity of the purified MWCNT products obtained at different temperatures through the bucky paper technique. The resistivity per square surface values of carbon nanotubes progressively decreases when they are synthesized at higher reaction temperatures. Several factors can influence the electrical conductivity of the tubes, for instance: their L/D aspect ratio, material purity, morphology properties of the CNTs, outer diameter, presence of structural defects, metallic/semiconducting CNTs composition, surface properties, etc.

TABLE 10
Synthesis of MWCNT using Catalyst B and ethane as carbon source at
different reaction temperatures and at 10 minutes reaction time.

| | | | MWCNT | | | |
|---|---|---|---|---|---|---|
| Ethane | | | content in | Bucky | CNT | |
| composition | Reaction | Reaction | the | paper | production | H₂ |
| in the gas | Temperature | time | product | resistivity | (g | produced |
| feed (V %) | (° C.) | (min) | (wt %) | (ohms/sq) | CNT/g · cat) | (L/g · cat) |
| 75 | 675 | 10 | 33 | 620 | 0.49 | 1.38 |
| 75 | 700 | 10 | 45 | 398 | 0.82 | 2.29 |
| 75 | 730 | 10 | 56 | 223 | 1.27 | 3.56 |
| 75 | 750 | 10 | 63 | 211 | 1.70 | 4.77 |

Example 8: Mechanical strength improvement by adding MWCNT-Al₂O₃ hybrid material into cement.

In this example, the MWCNT-Al₂O₃ hybrid materials obtained using ethylene and ethane as carbon sources and catalyst B (Examples 2 and 3) was mechanically blended in powder form with Portland Type I/II cement following the procedure described in the prior art (US20230116160A1). Specimens of CNT-Al₂O₃ and cement were prepared by adding water to the powder mixture at a ratio of 0.485 grams of H₂O per gram of cement in a blender. The MWCNT content in the cement is 0.20 wt %.

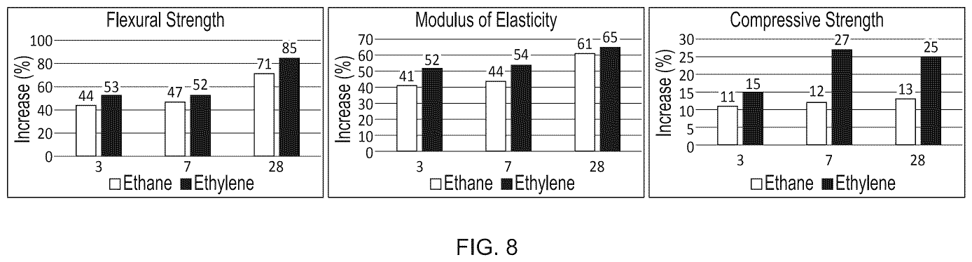

Mechanical strength tests were performed on the CNT-cement specimens as a function of curing time (3, 7, and 28 days). In FIG. 8, carbon nanotubes synthesized from ethylene and ethane significantly improve flexural strength, modulus of elasticity, and compressive strength compared to mortar (mortar being the baseline—0% increase) making these materials suitable for advanced construction material applications. It has been demonstrated that adding very low contents of carbon nanomaterials to the cementitious matrix allows partial replacement of cement with pozzolanic materials (such as limestone, fly ash, fume silica, calcined clays, and slags) in concrete production without modifying its mechanical properties, thus significantly reducing CO₂ emissions.

The present processes are effective to economically produce hydrogen from waste streams from refineries and petrochemical plants. The processes are also effective to economically produce CNTs along with the hydrogen. The production of hydrogen without the generation of carbon dioxide is highly desirable both environmentally and economically.

Table 11 provides the maximum hydrogen volume per gram of CNT produced in the present processes, for several different carbon sources (e.g., hydrocarbons) used in the process.

TABLE 11

| Hydrocarbon | Liters hydrogen per gram CNT |
|---|---|
| Methane | 3.73 |
| Ethane | 2.80 |
| Propane | 2.49 |
| Iso-butane | 2.33 |
| Ethylene | 1.87 |
| Propene | 1.87 |
| 1,2, and Iso-butene | 1.87 |

Example 9: Synthesis of MWCNT using a Ni/Al₂O₃ catalyst and methane as carbon source.

In this example, we have used methane as a carbon source, a Ni/Al₂O₃-based catalyst, which was prepared using the same procedure and active metal composition as the Co/Al₂O₃ catalyst in Example 1, a reaction temperature and time of 700° C. and 20 minutes, respectively. The reaction was carried out in a fluidized bed reactor using 30 grams of catalyst and a process gas flow of 10 L/min with a composition of 40 V % methane, 10 V % H₂, and 50 V % N₂. The obtained product contained 68% CNT, representing a methane conversion of 75.9% and an H₂ production of 8.09 L H₂/g catalyst.

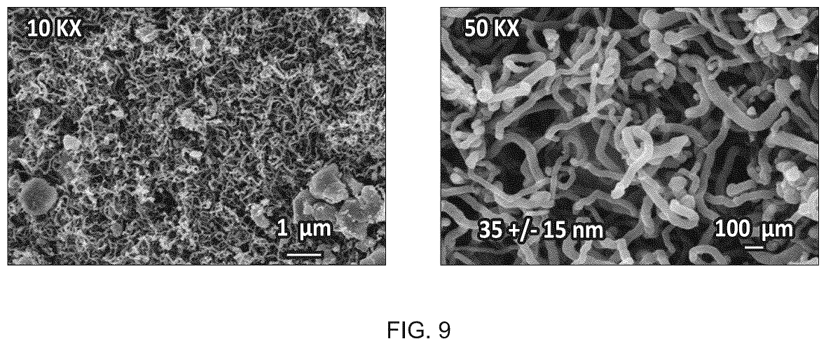

FIG. 9 shows SEM images taken at 10 KX and 50 KX magnifications (left to right respectively), where MWCNTs with diameters ranging from 20 to 50 nm are observed.

### Example 10

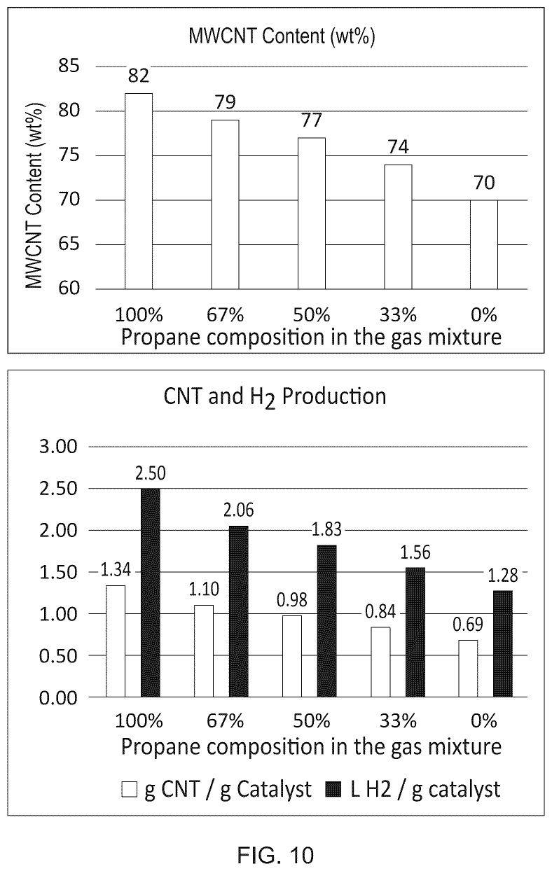

In this example, CNTs were synthesized using catalyst B and a carbon source consisting of propane and ethane mixtures with varying volume percentages. Catalytic activity tests were conducted in the rotary furnace reactor at 675° C. to evaluate the differences in carbon conversion between the different gas mixtures. The reaction time was 20 minutes. The results of these tests are shown in FIG. 10.

It can be observed that CNT and hydrogen production increases when the gas mixture is richer in propane. This is because longer-chain paraffins (like propane) are more reactive under moderate reaction conditions.

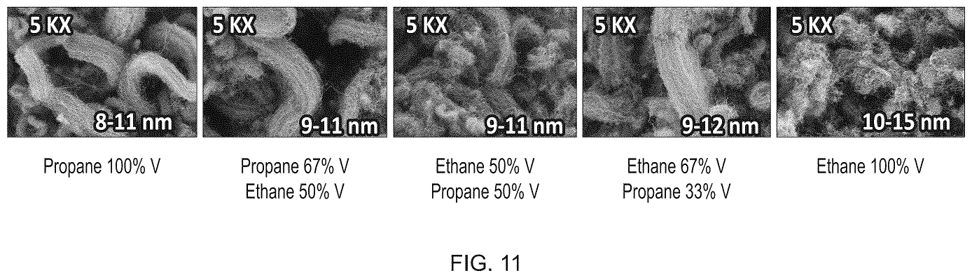

FIG. 11 shows SEM images at 5 KX magnification of MWCNT samples synthesized from different volume ratios of propane and ethane. The samples produced from propane show MWCNTs with a bundled morphology. Individual tubes have diameters between 8 and 11 nm.

In contrast, the sample synthesized using ethane exhibits MWCNTs with a “cotton ball” morphology, and the individual tube diameters range from 11 to 15 nm. Samples synthesized from mixtures of both gases show a combination of both morphologies, with tube diameters between 9 and 12 nm. A higher quantity of bundled MWCNTs is observed when the gas mixture is rich in propane.

FIG. 10 provides data concerning the synthesis of MWCNTs Using Catalyst B with Different Compositions of Ethane and Propane as Carbon Source.

FIG. 11 includes SEM images at 5KX magnification of MWCNTs synthesized using different ethane-propane gas mixture compositions (100% propane, 67% propane and 33% ethane, 50% propane and ethane, 33% propane and 67% ethane, and 100% ethane from left to right, respectively).

### Example 11

In this example, flare gas is used as the feed gas.

To enable downstream catalytic conversion of flare gas, the flare gas must first undergo purification to remove catalyst poisons and corrosive contaminants, particularly sulfur- and nitrogen-containing species, CO₂, and CO. Purification may be accomplished through adsorption (e.g., activated carbon, molecular sieves), absorption (e.g., amine solutions), membrane separation technologies, catalytic pre-reforming or treatment systems.

Once purified, the hydrocarbon-rich gas stream is introduced into a rotary tube reactor, operated at temperatures between 650° C. and 750° C., in the presence of a tailored catalytic formulation that promotes the growth of carbon nanotubes (CNTs) suitable for specific applications.

Unconverted hydrocarbons in the reactor effluent may be recycled to the reactor inlet, thereby improving feedstock utilization and process efficiency. Alternatively, the unconverted hydrocarbons can be flared; since some of the hydrocarbons will have been converted to CNTs and hydrogen, the environmental impact is substantial even in this case. Additionally, hydrogen present in the effluent can be selectively separated via membrane-based systems and subsequently used as a thermal energy source to maintain reactor operating temperatures, in electricity generation, or as a reactant in ancillary industrial processes. This integrated approach to flare gas utilization not only contributes to emission reductions but also facilitates the production of strategic materials, aligning with circular economy and sustainability principles.

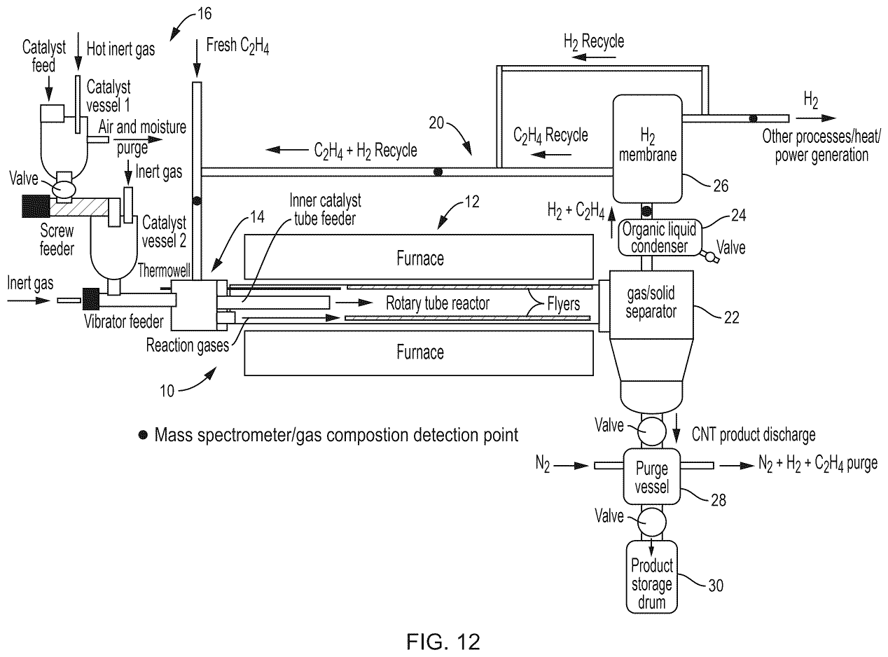

FIG. 12 is a schematic representation of an exemplary rotary tube reactor system 10 that is configured to be used to accomplish the carbon nanomaterial and hydrogen production described herein. The reactor and its use are described in US publication 2023/0109092, the disclosure of which is incorporated by reference herein. The following description illustrates certain aspects of the disclosure but is not limiting of the scope of the disclosure.

A catalyst feed system 16 can operate as follows. Catalyst particles in powder form are fed into the catalyst supply accumulation vessel 1. The air is subsequently removed from the catalyst supply accumulation vessel 1 using a flow of an inert gas. The inert gas can be preheated at temperatures between 60-150° C. to remove moisture from the catalyst during the purging process. The catalyst particles are then transferred to the second catalyst supply accumulation vessel 2 through a screw feeder. This equipment controls the amount of catalyst fed to the reactor 12. The catalyst and reaction gas feed system 14 can operate as follows. The catalyst particles contained in the second catalyst supply accumulation vessel are fed to the rotary tube reactor through a metal tube coupled to a vibrating catalyst particle feed system. The supply system is maintained in an inert gas atmosphere to inhibit unwanted reactions. When other material(s) are added along with the catalyst in order to produce CNT hybrid materials, these other material(s) can be fed together with the catalyst, or there can be a separate, parallel feed system for the other material(s). The second feed system can be the same as the catalyst feed system or otherwise configured to bring these material(s) to reaction temperature before they are fed into the reactor. In some examples the catalyst and other material(s) are pre-blended before being fed together into the reactor in the manner described above for the catalyst feed.

The tube that feeds catalyst/other materials into the reactor is long enough such that its end is located inside the rotary tube in the preheating zone of the furnace. In some examples the length of the inner tube is approximately ⅓ to ⅙ of the length of the rotary tube in the hot (reaction) zone of the furnace. In some examples the diameter of the inner tube is between ⅓ to ½ the diameter of the rotary tube. In some examples there are multiple heating zones of the reactor. In some examples the reactor is heated by gas or by electricity.

This arrangement results in the catalyst particles reaching the desired reaction temperature before coming into contact with the reaction gases. The inner tube is made of a special corrosion resistant metal/steel, such as Inconel, titanium, etc. The length and diameter of the inner tube relative to the rotary tube is selected to ensure efficient heat transfer during the catalytic process.

The temperature of the process gas and the catalyst particles in the place where they enter in intimate contact is measured through a thermocouple introduced into a thermowell located in the inlet block of the reactor, indicated by a solid black line. Depending on the type of material to be synthesized, flyers or other mass-distribution structures (indicated schematically in FIG. 12) can be placed in the rotating tube to improve the transfer of mass and heat between the solid particles and the reaction gas. Flyers can also improve material flow within the rotating tube. The residence time of the catalyst within the reactor is controlled through the tube rotation speed and its inclination angle.

The carbon nanomaterial product obtained is separated from the gas at the outlet of the reactor, for example using gas/solid separator 22. A system of valves discharges the product into containers (e.g., purge vessel 28) that have an inert gas injection to remove ethylene and hydrogen and cool the material before being packaged (e.g., in storage drum 30).

Liquid condenser 24 is used to remove undesired reaction by-products before hydrogen separation and removal or recycling of reaction gases.

Unreacted ethylene (or other carbon-source reaction gas) and hydrogen are subsequently separated using a H₂ membrane separator 26 that may comprise: organic polymers, nano-porous inorganic materials (ceramic, oxides, porous vycor glass, etc.), dense metal (Pd, and metal alloys), carbon and carbon-nanotubes based membranes, etc.

Unreacted carbon source is in some examples then recycled by recycle system 20, and the hydrogen can be used for other catalytic industrial processes, or for other purposes such as for power or heat generation or for transportation. The recycled gas can contain hydrocarbon source gas(es) and hydrogen which facilitates the production reaction of carbon nanotubes and potentially hybrid materials through improved heat transfer and catalyst activation. The amount of fresh hydrocarbon gas to be fed to the reactor will depend on the level of conversion in the production of carbon nanotubes/hybrid materials. An alternative to hydrocarbon gas recycle is flaring of the effluent after hydrogen separation.

The gas composition can be detected at several points as indicated in FIG. 12, using a mass spectrometer or other instrument. The composition data can be used for process control and for other purposes, such as for recording gas composition and quality. A controller (not shown in FIG. 1) is input with the gas composition data (and other variables) and controls valves, heaters, particle feeders and other process equipment (not all shown in FIG. 1) that is used to maintain desired process conditions.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A method of producing at least carbon nanotubes (CNT) in the reaction zone of a rotary tube reactor or a fluidized bed reactor that has an outlet, wherein the reaction zone is heated to a reaction temperature between 60° and 900° C., the method comprising:
providing into the reaction zone at the reaction temperature a CNT catalyst comprising a transition-metal active catalyst supported on metal oxide particles having a high specific surface area;
flowing through the reaction zone a process gas comprising a gaseous mixture of a hydrocarbon and hydrogen, wherein the hydrocarbon comprises at least one of methane, ethane, propane, butane, iso-butane, propene, 1-butene, 2-butene, and iso-butene, wherein the hydrocarbon decomposes at the catalyst sites into CNT and hydrogen; and
separating hydrogen from the gases that exit the reactor through the reactor outlet.

2. The method of claim 1 wherein the hydrogen volume in the process gas is from 40% to 95% of the hydrocarbon volume.

3. The method of claim 1 further comprising recycling back into the process gas at least one of separated hydrogen and hydrocarbon gases.

4. The method of claim 1 wherein the CNT comprises from 30 to 95% by weight of the product produced using the reactor.

5. The method of claim 1 wherein the metal oxide particles make up from 90 to 99.5% by weight of the CNT catalyst.

6. The method of claim 1 wherein the active catalyst makes up from 0.5 to 10% by weight of the CNT catalyst.

7. The method of claim 1 wherein the active catalyst of the CNT catalyst is present in the form of catalyst grains that have a particle size of less than 500 microns for the rotary tube reactor and from 150-500 microns for the fluidized bed reactor.

8. The method of claim 1 wherein the CNT catalyst metal oxide particles comprise alumina support particles that are composed of elementary particles with sizes ranging from 600 to 1,500 nanometers.

9. The method of claim 1 wherein the hydrocarbon in the process gas comprises methane.

10. The process of claim 1 wherein the hydrocarbon in the process gas comprises methane and ethane.

11. The process of claim 1 wherein the hydrocarbon in the process gas comprises propane.

12. The process of claim 1 wherein the hydrocarbon in the process gas comprises propane and at least one of ethane and butane.

13. The process of claim 1 wherein the process gas comprises flare gas.

14. The process of claim 13 further comprising removing at least one of sulfur and sulfur compounds from the flare gas before it is flowed through the reaction zone.

15. The process of claim 1 wherein the process gas comprises natural gas.

16. The process of claim 1 wherein the process gas comprises liquified petroleum gas.

17. A process for the production of hydrogen, comprising:
providing a rotary tube reactor with a reaction zone, wherein the reaction zone is heated to a reaction temperature between 60° and 900° C.;
providing into the reaction zone a catalyst comprising a transition-metal active catalyst supported on metal oxide particles having a high specific surface area;
flowing through the reaction zone a process gas comprising a gaseous mixture of at least one hydrocarbon and hydrogen, wherein the hydrocarbon comprises at least one of methane, ethane, propane, butane, iso-butane, propene, 1-butene, 2-butene, and iso-butene, wherein the hydrocarbon decomposes at the catalyst sites into carbon and hydrogen; and
separating hydrogen from the gases that exit the reactor.

18. The process of claim 17 wherein the hydrocarbon further comprises at least one of a C5 compound and a C6 compound.

19. The process of claim 18 wherein the C5 compound comprises at least one of pentane, iso-paraffins and olefins.

20. The process of claim 18 wherein the C6 compound comprises at least one of benzene, toluene, xylene, paraffins and aromatics.
